(19) United States
(12) Patent Application Publication
(10) Pub. No.: US 2012/0184425 A1
(43) Pub. Date: Jul. 19, 2012

(54) SHEET PROCESSING APPARATUS

(75) Inventors: Naoto YOSHIDA, Hino-shi (JP); Hisao HOSOYA, Sagamihara-shi (JP)

(73) Assignee: Konica Minolta Business Technologies, Inc., Chiyoda-ku (JP)

(21) Appl. No.: 13/347,763

(22) Filed: Jan. 11, 2012

(30) Foreign Application Priority Data
Jan. 13, 2011 (JP) 2011-004574

(51) Int. Cl. B41L 43/08

(52) U.S. Cl. 493/442

(57) ABSTRACT

A sheet processing apparatus having: a first roller pair for nipping a sheet so as to subject the sheet to first folding; a stopper member for stopping advance of the sheet after the first folding; a guide for flexing the sheet whose advance is stopped by the stopper member; a second roller pair for nipping the sheet flexed by the guide so as to subject the sheet to second folding; and a switch member for leading the sheet to be subjected to the second folding onto a first path having the stopper member mounted thereon, and leading the sheet to be subjected only to the first folding onto a second path connected to an outside of the apparatus, wherein the guide comes into stronger contact with the sheet to be subjected to the first folding and the second folding than the sheet to be subjected only to the first folding.

This application is based on Japanese Patent Application No. 2011-004574 filed on Jan. 13, 2011, the content of which is incorporated herein by reference.

### BACKGROUND OF THE INVENTION

1. Field of the Invention

The present invention relates to a sheet processing apparatus, and particularly relates to a sheet processing apparatus for bending a print medium.

2. Description of Related Art

As a conventional sheet processing apparatus, there is known, for example, a sheet folding apparatus disclosed in Japanese Patent Laid-Open Publication No. 2009-173430. Japanese Patent Laid-Open Publication No. 2009-173430 discloses the sheet folding apparatus in which a conveying unit conveys a sheet whose tip is stopped by a tip stopping member so as to bend the sheet, the sheet folding apparatus including a folding assist member in such a manner as to securely bend the sheet toward a folding unit. In this manner, the sheet folding apparatus disclosed in Japanese Patent Laid-Open Publication No. 2009-173430 can securely fold the sheet in three.

The sheet folding apparatus disclosed in Japanese Patent Laid-Open Publication No. 2009-173430 has experienced a problem that a paper jam is liable to occur. More particularly, in order to securely bend a sheet, it is preferable that the folding assist member should be brought into strong contact with the sheet. Moreover, the folding assist member comes into contact with a sheet to be folded in two. When the folding assist member comes into strong contact with the sheet to be folded in two, the sheet to be folded in two is prevented from being conveyed. In other words, a jam occurs in the sheet folding apparatus.

### SUMMARY OF THE INVENTION

A sheet processing apparatus according to one aspect of the present invention includes: a first roller pair for nipping a sheet therein so as to subject the sheet to first folding; a stopper member for stopping advance of the sheet after the first folding; a guide for flexing the sheet whose advance is stopped by the stopper member; a second roller pair for nipping the sheet flexed by the guide so as to subject the sheet to second folding; and a switch member for leading the sheet to be subjected to the second folding onto a first path having the stopper member mounted thereon, and leading the sheet to be subjected only to the first folding onto a second path connected to an outside of the apparatus, wherein the guide comes into stronger contact with the sheet to be subjected to the first folding and the second folding than the sheet to be subjected only to the first folding.

### BRIEF DESCRIPTION OF THE DRAWINGS

The features of the present invention will be apparent from the following description with reference to the accompanying drawings, in which:

FIG. 1 is a view showing the configuration of a sheet processing apparatus;

FIG. 2 is a view showing the configuration of a processing unit included in the sheet processing apparatus;

FIG. 3 is a view showing the processing unit when a sheet is folded in three;

FIG. 4 is a view showing the processing unit when a sheet is folded in two;

FIGS. 5A to 5C are views showing the configuration of a guide in a first modification; and

FIGS. 6A to 6C are views showing the configuration of a guide in a second modification.

### DETAILED DESCRIPTION OF THE PREFERRED EMBODIMENT

A detailed description will be given below of a sheet processing apparatus in a preferred embodiment according to the present invention with reference to the attached drawings.

### Configuration of Sheet Processing Apparatus

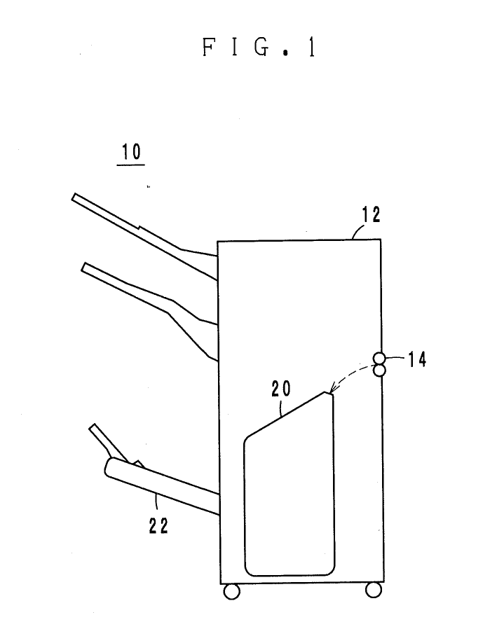

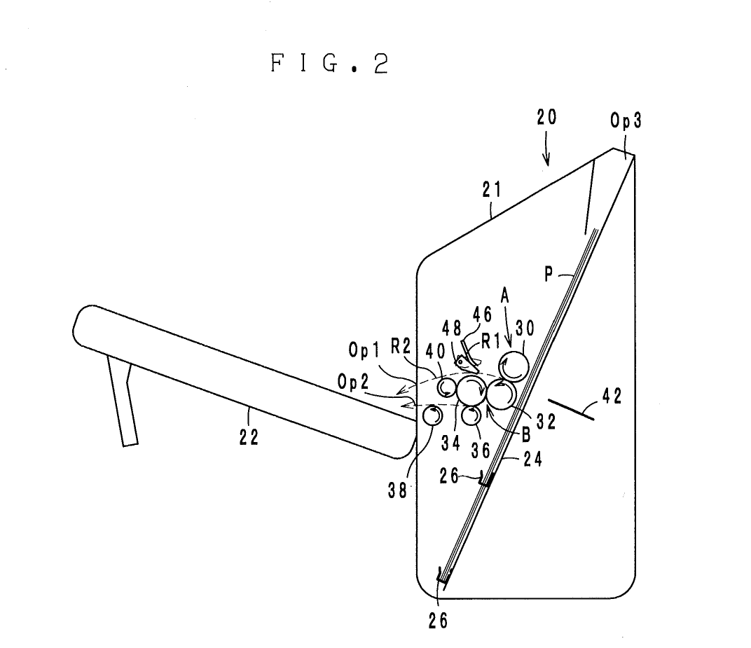

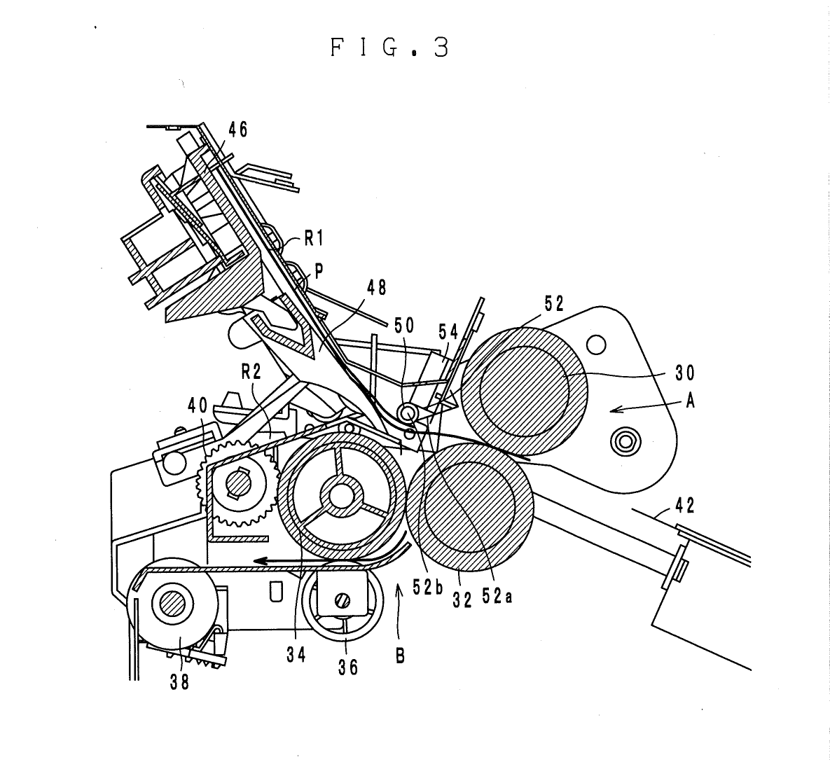

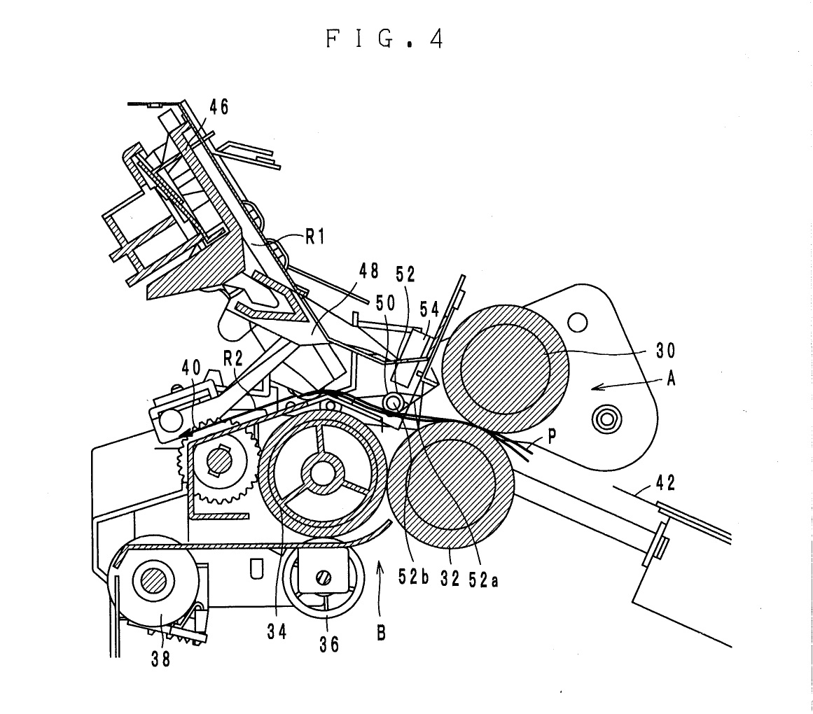

First, description will be made on the configuration of a sheet processing apparatus 10. FIG. 1 is a view showing the configuration of the sheet processing apparatus 10; FIG. 2 is view showing the configuration of a processing unit 20 included in the sheet processing apparatus 10; FIG. 3 is a view showing the processing unit 20 when a sheet P is folded in three; and FIG. 4 is a view showing the processing unit 20 when the sheet P is folded in two. Hereinafter, the right and the left in FIGS. 1 to 4 are simply referred to as the right and the left; the upper side and the lower side in FIGS. 1 to 4 are simply referred to as the upper side and the lower side; and the front and the back in the drawing sheets of FIGS. 1 to 4 are simply referred to as the front and the back.

The sheet processing apparatus 10 is used in connection to an image forming apparatus such as a copying machine. The sheet processing apparatus 10 subjects the sheet P that has been printed, which is output from an image forming apparatus, to folding and stapling. The sheet processing apparatus 10 is provided with a main body 12, a roller pair 14, the processing unit 20, and a tray 22, as shown in FIGS. 1 and 2.

The main body 12 is a casing for the sheet processing apparatus 10, and houses therein the roller pair 14 and the tray 22.

The roller pair 14 projects from the main body 12 at the right side surface of the main body 12, and further, is adapted to take the sheet P that has been printed, which is output from the image forming apparatus, into the main body 12. The sheet P which has been taken into the main body 12 by the roller pair 14 is conveyed to the processing unit 20 by roller pairs and guides, not shown, as shown in FIG. 1.

The processing unit 20 subjects the sheet P to folding (in three or two). As shown in FIG. 2, the processing unit 20 is provided with a main body 21, a stack tray 24, a stopper 26, rollers 30, 32, 34, 36, 38, and 40, a chopper 42, a stopper (i.e., a stopping member) 46, a switching member 48, and a guide 50 (see FIGS. 3 and 4). Herein, folding in three means that the sheet P is folded twice (hereinafter referred to as first folding and second folding) in such a manner as to achieve a size of one third, and folding in two means that the sheet P is folded once (hereinafter referred to as first folding) in such a manner as to achieve a size of a half.

The main body 21 is a casing for the processing unit 20, and houses therein the stack tray 24, the stopper 26, the rollers 30, 32, 34, 36, 38, and 40, the chopper 42, the stopper 46, the switching member 48, and the guide 50. A plurality of (two) discharge ports Op1 and Op2 are provided at the left side surface of the main body 21, for outputting the sheet P that has been folded. From the discharge port Op1 is output the sheet P after being folded in two. In contrast, from the discharge port Opt is output the sheet P after being folded in three. Moreover, an intake port Op3 for taking in the sheet P which has been conveyed via the roller pair 14 is provided at the upper surface of the main body 12.

The stack tray 24 is a flat plate which vertically extends inside of the main body 21, and specifically, extends slantwise upward on the right. On the stack tray 24 is stacked the sheet P taken in from the intake port Op3.

The stopper 26 is adapted to align the plurality of sheets P such that the sheets P are stacked in alignment on the stack tray 24. Specifically, the stopper 26 has a structure formed into a U shape in cross section, and is mounted on the stack tray 24. The plurality of sheets P slip down on the stack tray 24 by their own weight, so as to come into contact with the stopper 26 in alignment. Here, the stopper 26 can vertically slide on the stack tray 24.

The chopper 42 is a plate-like member for bending the sheet P. The chopper 42 is disposed opposite to the sheets P stacked on the stack tray 24 with respect to the stack tray 24, and is positioned near the middle point in the vertical direction of the stack tray 24. The chopper 42 is configured to be freely moved in a direction perpendicular to the stack tray 24. The chopper 42 can form a fold projecting leftward on the sheet P in contact with the sheet P on the right.

Each of the rollers 30, 32, 34, 36, 38, and 40 fulfills the function of conveying the sheet P. The rollers 30 and 32 are disposed opposite to each other, thus forming a roller pair A which is positioned opposite to the chopper 42 with respect to the stack tray 24. The roller pair A nips the sheet P and subjects it to the first folding.

The stopper 46 has a structure formed into a U shape in cross section, and has an opening oriented downward. The stopper 46 is used in folding the sheet P in three. The stopper 46 stops the advance of the sheet P which has been first folded by the chopper 42 and the roller pair A and then has been conveyed by the roller pair A.

The guide 50 flexes the sheet P which has stopped from advancing by the stopper 46. Specifically, as shown in FIGS. 3 and 4, the guide 50 includes a contact member 52 and an auxiliary member 54. The contact member 52 includes a film 52a and a core 52b. The core 52b is a rod-like member extending from the front to the back and having a round cross section. The film 52a is made of a flexible material, and is wound around the core 52b. Moreover, the upper end of the film 52a is fixed to the core 52b, so that the contact member 52 is suspended downward on the left of the roller pair A. The contact member 52 having the above-described configuration can laterally oscillate by the flexibility of the film 52a. As shown in FIG. 3, the contact member 52 comes into contact with the sheet P in such a manner as to press down the upper surface of the sheet P which is subjected to the second folding. The auxiliary member 54 is an elastic member for pressing the contact member 52 to the sheet P when the contact member 52 comes into contact with the sheet P which is subjected to the second folding. In this manner, the sheet P which is subjected to the second folding is flexed in such a manner as to project downward as the sheet P is fed by the roller pair A.

The roller 34 is disposed on the left of the roller 32 and faces the roller 32, thereby forming a roller pair B. The roller pair B nips the sheet P, which has been flexed by the guide 50, and then, subjects the sheet P to the second folding, as shown in FIG. 3.

The roller 36 is disposed on the lower side of the roller 34 and faces the roller 34. The roller 38 is disposed on the left of the roller 36. The rollers 36 and 38 are adapted to feed the sheet P, which has been subjected to the second folding by the roller pair B, to the discharge port Op2.

The roller 40 is disposed on the left of the roller 34 and faces the roller 34. The roller 40 is designed to feed the sheet P, which has been subjected to the second folding by the roller pair B, to the discharge port Op2.

The switch member 48 is a member for switching feed paths for the sheet P, and is oscillatably disposed on the lower side of the stopper 46. Specifically, the switch member 48 indicated by a solid line in FIG. 2 (FIG. 3) leads the sheet P, which is subjected to the second folding, onto a path R1 on which the stopper 46 is disposed. Meanwhile, the switch member 48 indicated by a dotted line in FIG. 2 (FIG. 4) leads the sheet P, which is subjected only to the first folding, onto another path R2 connected to the outside of the main body 21.

In this case, the path R1 extends from the roller pair A upward on the left whereas the path R2 extends from the roller pair A downward on the left. In other words, the path R1 is more separate from the roller pair A than the path R2. In this manner, as shown in FIGS. 3 and 4, the sheet P led onto the path R1 is more largely flexed in such a manner as to project downward than the sheet P led onto the path R2.

On the tray 22 is placed the sheet P to be output from the processing unit 20.

### Folding Processing

Next, a description will be given of the folding processing in the processing unit 20 with reference to the drawings. The processing unit 20 can cope with both of the processing for folding the sheet P in two and the processing for folding the sheet P in three.

First, description will be made on the case where the sheet P is folded in two. At the time of folding in two, the stopper 26 is located at the lower end of the stack tray 24, as indicated by a dotted line in FIG. 2. Consequently, the chopper 42 is located at the middle point of the sheet P in the vertical direction. Moreover, the switch member 48 closes the opening of the stopper 46, as shown in FIG. 4.

The chopper 42 comes into contact with the sheet P from the right, forms a fold at the middle point of the sheet P in the vertical direction, and then, pushes the sheet P into between the rollers 30 and 32. The rollers 30 and 32 are rotated clockwise and counterclockwise, respectively. As a consequence, the sheet P is output from between the rollers 30 and 32 in the state folded in two, as shown in FIG. 4. The sheet P being fed by the rollers 30 and 32 pushes up the guide 50 while advancing leftward, as shown in FIG. 4. Here, the switch member 48 leads the sheet P onto the path R2, and therefore, the sheet P advances downward on the left. In this manner, the contact member 52, which has been pushed up by the sheet P, comes out of contact with the auxiliary member 54. Consequently, force to be applied to the sheet P by the guide 50 is relatively small. Thereafter, the sheet P is fed by the roller 40, which is rotated clockwise, while being led to the discharge port Op1 on the path R2. Finally, the sheet P is output from the discharge port Op1 onto the tray 22.

Next, description will be made on the case where the sheet P is folded in three. At the time of folding in three, the stopper 26 is located at a ⅓ position from the bottom of the stack tray 24, as indicated by a solid line in FIG. 2. Consequently, the chopper 42 is located at the ⅓ position from the bottom of the sheet P. As shown in FIG. 3, the switch member 48 releases the opening of the stopper 46.

The chopper 42 comes into contact with the sheet P from the right, forms a fold at the ⅓ position from the bottom of the sheet P, and then, pushes the sheet P into between the rollers 30 and 32. The sheet P being fed by the rollers 30 and 32 pushes up the guide 50 while advancing leftward, as shown in FIG. 3. Here, the switch member 48 leads the sheet P onto the path R1, and therefore, the sheet P advances upward on the left. In this manner, the contact member 52, which has been pushed up by the sheet P, comes into contact with the auxiliary member 54. Consequently, force to be applied to the sheet P by the guide 50 is relatively large. In other words, the guide 50 is designed to be brought into stronger contact with the sheet P which is subjected to the first folding and the second folding than the sheet P which is subjected to only the first folding.

Thereafter, the sheet P is fed by the rollers 30 and 32 while being led by the switch member 48, and then, advances into the stopper 46. When the tip of the sheet P touches the back of the stopper 46, the sheet P stops advancing leftward. Here, the rollers 30 and 32 are rotated, and further, the contact member 52 comes into contact with the sheet P. Therefore, the sheet P is flexed in such a manner as to project downward, and then, advances between the rollers 32 and 34, as shown in FIG. 3. Here, the roller 34 is rotated clockwise. Therefore, the sheet P is fed downward by the rollers 32 and 34. At this time, the fold is formed at the ⅓ position from the top of the sheet P. That is to say, the sheet P is folded in three. The sheet P is fed by the rollers 36 and 38 while being led to the discharge port Opt onto the path R1. Finally, the sheet P is output from the discharge port Opt onto the tray 22.

### Effects

As described above, the sheet processing apparatus 10 can securely fold the sheet in three, and further, can suppress a jam from occurring. More particularly, it is preferable in the sheet folding apparatus disclosed in Japanese Patent Laid-Open Publication No. 2009-173430 that the folding auxiliary member should come into strong contact with the sheet so as to securely bend the sheet. On the other hand, the folding auxiliary member is also designed to come into contact with the sheet to be folded in two. When the folding auxiliary member is brought into strong contact with the sheet to be folded in two, the sheet to be folded in two is prevented from being fed. In other words, a jam occurs in the sheet folding apparatus. That is to say, securely folding in three is incompatible with suppressing a jam from occurring.

In contrast, in the sheet processing apparatus 10, the guide 50 comes into stronger contact with the sheet P to be folded twice (that is, the sheet P to be folded in three) than the sheet P to be folded only once (that is, the sheet P to be folded in two). As a consequence, when the sheet P to be folded in two is led onto the path P2, the guide 50 comes into relatively weak contact with the sheet P, and therefore, the guide 50 does not prevent the sheet P from being fed. Moreover, when the sheet P to be folded in three is led onto the path R1, the guide 50 is brought into relatively strong contact with the sheet P, and therefore, the sheet P is securely flexed downward. Thus, the sheet P is securely folded in three.

In the sheet processing apparatus 10, when the contact member 52 comes into contact with the sheet P to be folded in three, the auxiliary member 54 pushes the contact member 52 against the sheet P; in contrast, when the contact member 52 comes into contact with the sheet P to be folded in two, the auxiliary member 54 comes out of contact with the contact member 52. Since the guide 50 has the above-described configuration, it comes into stronger contact with the sheet P to be folded in three than the sheet P to be folded in two.

### First Modification

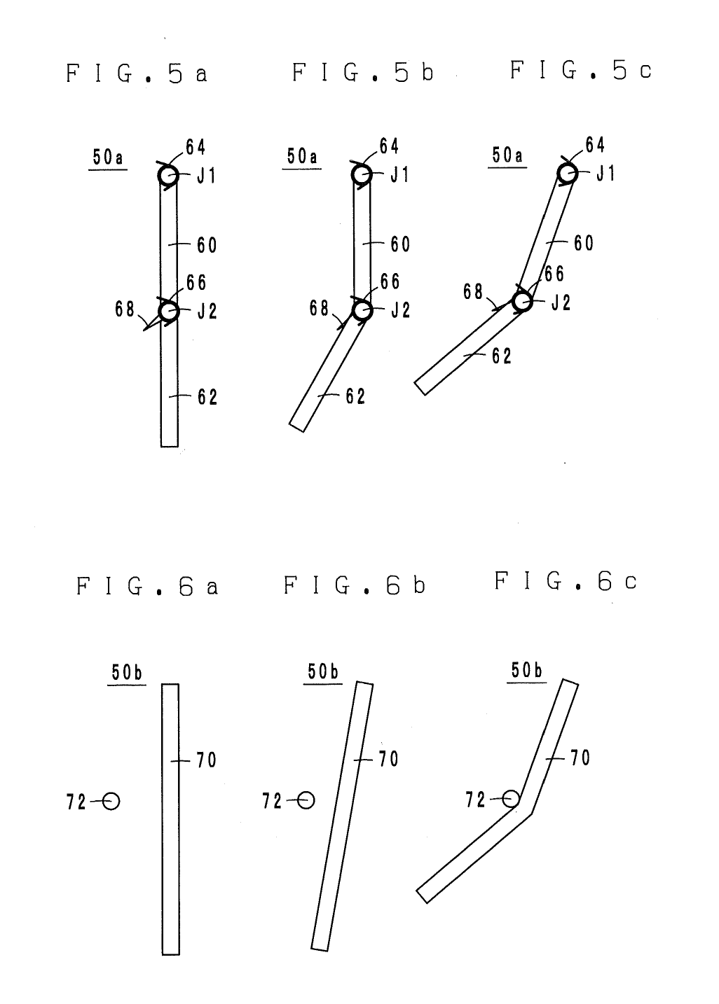

A description will be given below of a guide in a first modification with reference to the drawings. FIGS. 5A to 5C are views showing the configuration of a guide 50a in the first modification. In FIG. 5A, the sheet P is not brought into contact with the guide 50a. In FIG. 5B, the sheet P to be folded in two is brought into contact with the guide 50a. In FIG. 5C, the sheet P to be folded in three is brought into contact with the guide 50a.

The guide 50a is a plate-like member having two joints which are foldable downstream in a sheet feed direction. Specifically, the guide 50a is configured by plate-like members 60 and 62 and torsion coil springs 64 and 66. The plate-like member 60 is attached to the main body 21 in such a manner as to be freely oscillated in a lateral direction on the upper end of the plate-like member 60. A joined part between the plate-like member 60 and the main body 21 is referred to as a joint J1. Moreover, the plate-like member 62 is attached to the lower end of the plate-like member 60 in such a manner as to be freely oscillated in a lateral direction on the upper end of the plate-like member 62. A joined part between the plate-like member 60 and the plate-like member 62 is referred to as a joint J2. To the joints J1 and J2 are attached torsion coil springs 64 and 66, respectively. The torsion coil spring 64 urges the plate-like member 60 against the main body 21 in such a manner as to rotate the plate-like member 60 counterclockwise. Here, as shown in FIGS. 5A to 5C, a stopper, not shown, is provided for keeping a vertically extending attitude, in the state in which the plate-like member 60 does not receive any external force. In the same manner, the torsion coil spring 66 urges the plate-like member 62 against the plate-like member 60 in such a manner as to rotate the plate-like member 62 counterclockwise. Here, as shown in FIGS. 5A to 5C, the stopper, not shown, is provided for keeping the vertically extending attitude, in the state in which the plate-like member 62 does not receive any external force.

The joint J2 includes a stopper 68 for restricting the rotation of the plate-like member 62 in such a manner as to prevent the plate-like member 62 from being inclined at a predetermined angle or more with respect to the plate-like member 60.

In the guide 50a configured as described above, the spring constant of the torsion coil spring 64 is greater than that of the torsion coil spring 66. Consequently, the joint J1 is hardly folded and bent than the joint J2.

Next, operation of the guide 50a will be described. When the sheet P which is subjected to only the first folding (i.e., the sheet P to be folded in two) is brought into contact with the guide 50a, only the joint J2 is folded and bent, as shown in FIG. 5B. In contrast, when the sheet P which is subjected to the second folding (i.e., the sheet P to be folded in three) is brought into contact with the guide 50a, the joints J1 and J2 are folded and bent, as shown in FIG. 5C. In this manner, the guide 50a is brought into stronger contact with the sheet P which is subjected to the first folding and the second folding (i.e., the sheet P to be folded in three) than the sheet P which is subjected to only the first folding (i.e., the sheet P to be folded in two).

### Second Modification

A description will be given below of a guide in a second modification with reference to the drawings. FIGS. 6A to 6C are views showing the configuration of a guide 50b in the second modification. In FIG. 6A, the sheet P is not brought into contact with the guide 50b. In FIG. 6B, the sheet P to be folded in two is brought into contact with the guide 50b. In FIG. 6C, the sheet P to be folded in three is brought into contact with the guide 50b.

The guide 50b is configured by a plate-like member 70 and a strut 72. The plate-like member 70 is made of an elastic material which can be flexed downstream in the feed direction of the sheet P (i.e., leftward). The strut 72 is disposed more downstream in the feed direction of the sheet P (i.e., leftward) than the plate-like member 70.

Next, operation of the guide 50b will be described. When the sheet P which is subjected to only the first folding (i.e., the sheet P to be folded in two) is brought into contact with the plate-like member 70, the plate-like member 70 is flexed without any contact with the strut 72, as shown in FIG. 6B. In this case, since the plate-like member 70 is flexed as a whole, the plate-like member 70 is brought into relatively weak contact with the sheet P.

In contrast, when the sheet P which is subjected to the second folding (i.e., the sheet P to be folded in three) is brought into contact with the plate-like member 70, the plate-like member 70 is brought into contact with the strut 72, and further, is flexed on the strut 72 which serves as a fulcrum, as shown in FIG. 6C. In this case, since the plate-like member 70 is flexed at the tip thereof beyond a portion in contact with the strut 72, the plate-like member 70 is brought into relatively strong contact with the sheet P.

The above-described guide 50b is brought into stronger contact with the sheet P which is subjected to the first folding and the second folding (i.e., the sheet P to be folded in three) than the sheet P which is subjected to only the first folding (i.e., the sheet P to be folded in two).

Thus, the sheet processing apparatus according to the embodiment is excellent in certainly folding the sheet in three and in suppressing the occurrence of a jam.

Although the present invention has been described in connection with the preferred embodiment above, it is to be noted that various changes and modifications are possible to those who are skilled in the art. Such changes and modifications are to be understood as being within the scope of the present invention.

What is claimed is:

1. A sheet processing apparatus comprising:
a first roller pair for nipping a sheet therein so as to subject the sheet to first folding;
a stopper member for stopping advance of the sheet after the first folding;
a guide for flexing the sheet whose advance is stopped by the stopper member;
a second roller pair for nipping the sheet flexed by the guide so as to subject the sheet to second folding; and
a switch member for leading the sheet to be subjected to the second folding onto a first path having the stopper member mounted thereon, and leading the sheet to be subjected only to the first folding onto a second path connected to an outside of the apparatus,
wherein the guide comes into stronger contact with the sheet to be subjected to the first folding and the second folding than the sheet to be subjected only to the first folding.

2. The sheet processing apparatus according to claim 1, wherein the sheet to be led onto the first path is more flexed than the sheet to be led onto the second path.

3. The sheet processing apparatus according to claim 1, wherein the guide includes:
a contact member which is made of a flexible material and comes into contact with the sheet; and
an auxiliary member for pressing the contact member against the sheet when the contact member comes into contact with the sheet to be subjected to the second folding,
the contact member comes out of contact with the auxiliary member when the contact member comes into contact with the sheet to be subjected only to the first folding.

4. The sheet processing apparatus according to claim 1, wherein the guide is a plate-like member having a first joint and a second joint which can be folded downstream in a feed direction of the sheet,
the first joint being hardly folded than the second joint,
the first joint being folded when the sheet to be subjected to the second folding comes into contact with the guide, and
the second joint being folded when the sheet to be subjected only to the first folding comes into contact with the guide.

5. The sheet processing apparatus according to claim 1, wherein the guide includes:
a plate-like member made of an elastic material which can be flexed downstream in the feed direction of the sheet; and
a strut disposed more downstream in the feed direction of the sheet than the plate-like member,
the plate-like member being flexed without any contact with the strut when the sheet to be subjected only to the first folding is brought into contact with the plate-like member, and
the plate-like member being brought into contact with the strut and flexed on the strut which serves as a fulcrum when the sheet to be subjected to the second folding is brought into contact with the plate-like member.
